(19) United States
(12) Patent Application Publication
(10) Pub. No.: US 2008/0098799 A1
(43) Pub. Date: May 1, 2008

(54) Hydrogen and/or Oxygen Sensor

(76) Inventors: Donald W. Kirk, Caledon (CA); John W. Graydon, Toronto (CA)

Correspondence Address: GOWAN INTELLECTUAL PROPERTY, 1075 NORTH SERVICE ROAD WEST, SUITE 203, OAKVILLE, ON, L6M-2G2, US

(21) Appl. No.: 11/552,728

(22) Filed: Oct. 25, 2006

(51) Int. Cl. G01N 25/00

(52) U.S. Cl. 73/25.01

(57) ABSTRACT

A sensor is provided which is able to determine the level of contaminant gas within a gas stream. In particular, the sensor is able to detect the level of hydrogen gas contamination within an oxygen containing gas stream, or the oxygen gas contamination within a hydrogen containing gas stream. The sensor has a first temperature measurement device which measures a first temperature within a catalyst bed which catalyst bed catalytically effects the reaction of hydrogen and oxygen to produce heat. The first temperature is compared to the temperature of the original gas stream measured using a second temperature measurement device. The difference in the first and second temperatures provides a heat signature which can be related to the contaminant gas concentration. A simple, cost effective and reliable contaminant gas sensor is provided.

### FIELD OF THE INVENTION

This invention relates to a device for determining the concentration of hydrogen in an oxygen containing gas stream or the concentration of oxygen in a hydrogen containing gas stream.

### BACKGROUND TO THE INVENTION

As is well known in the field, gaseous hydrogen and oxygen form an explosive mixture between 4 and 94% oxygen. Thus, detection of the concentration of the oxygen or air content of a hydrogen gas stream at values below the explosive limit is essential for setting alarms and/or for process control purposes. Similarly, if oxygen is produced via electrolysis or is used in a fuel cell where hydrogen contamination is possible, having a sensor which will provide a reliable value of the concentration of hydrogen in the oxygen or air stream is again essential for setting alarms and/or for process control.

There are numerous ways in which an explosive mixture of oxygen and hydrogen might be formed. The most obvious examples involve water electrolysis and fuel cells. In the first case, water is split into oxygen and hydrogen gases via the application of direct current (DC) electrical power. These gases are kept separated via membranes, ionic barriers or fluid barriers. If any of these barriers are compromised during electrolysis, a quantity of hydrogen in the oxygen gas stream or a quantity of oxygen in the gas stream could be produced. Since the gases are colourless and odourless, their mixture cannot be readily detected and an unsafe operation could unknowingly result. A sensor which could detect and determine gas concentrations and warn of the approach of the gas mixture concentrations to their explosive limit would be very beneficial in being able to provide an alarm for the operator.

For a fuel cell such as a Polymer Electrolyte Membrane (PEM) Fuel Cell or an Alkaline Fuel Cell (AFC), hydrogen and oxygen or hydrogen and air are delivered to separated compartments (anode and cathode) in the fuel cell. The gaseous separation of the anode and cathode compartments is accomplished by a hydrophilic barrier or membrane or diaphragm or fluid barrier. If any of these barriers fail during operation there is an opportunity for the gases to mix and produce an explosive mixture. Electrolysers and fuel cells are usually operated with many individual cells connected in a stack and thus the opportunity for a failure of one or more membranes, diaphragms or fluid barriers is increased. A sensor which could provide a continuous signal indicating the concentration of the gas mixture would be highly desirable. The signal could be used to monitor gas purity, monitor changes in gas composition or be set to trigger an alarm if the concentration approached a dangerous composition.

As a result of the absence of a commercial device or a proposed device in the literature that would provide a quantitative signal for low concentrations of hydrogen in air or oxygen, or a low concentration of oxygen in hydrogen up to the explosive limit, provision of a sensor that would preferably satisfy or provide any or all of the requirements of quantitative measurement, reliable operation, long term durability, continuous operation and be economical, would be desirable.

### PRIOR ART

Many methods have been described in the literature for the detection of oxygen in a hydrogen gas stream. Bristol, in U.S. Pat. No. 6,812,708, describes how two sensing elements can be powered to maintain a constant temperature in the sensing elements and then use the required power as a measure of the concentration of the gas phase mixture. Clearly the use of a powered measurement circuit adds complexity to the sensor and this approach is not used in the current invention.

Suzuki, et al. in U.S. Pat. No. 6,336,354 describe a gas concentration measuring apparatus which measures the concentration of a given gas using a gas sensor which has a heater for the gas sensing element. The use of power and a sensor which is in direct contact with the gas are elements is a disadvantage which also is not present in the current invention.

Kato, et al. describe in U.S. Pat. No. 5,922,287 a method for measuring the concentration of a combustible gas by means of a combustible gas sensor. With this approach, there is no powered or heated sensor element as required by the previous examples. However, in claim 1 there is a requirement for “a porous oxidation catalyst layer which covers at least a part of a surface of the second temperature sensitive portion in which said second resistor is buried to catalyze oxidation of a combustible gas”. It is clear that one part of the sensor must be in contact with the gas phase to affect the catalysis and heat generation. This approach puts the sensor element in contact with the gas phase and makes it susceptible to corrosion or poisoning. The current invention avoids contact of the sensor element with the gas phase and provides a direct quantitative signal which is not available in the Kato et al. document. Also, from Claim 1 of the Kato et al. document, it is clear that there must be a resistor element for the measurement circuit. This resistor element is also not used in the current invention.

Van De Vyver et al., in U.S. Pat. No. 5,902,556, describe a catalytic detector for a flammable gas comprising a substrate and a sensing structure suspended from the substrate. The sensing structure includes a heating element. The present invention however, does not include a heating element nor a suspended sensing structure.

Wind et al., in U.S. Pat. No. 5,804,703, describe “a combustible gas sensor comprising: a bridge circuit having first and second legs . . . and a second temperature responsive resistive sensor element coupled between the bottom of the bridge and ground and located in the flow of combustible gas; . . . ”. As noted earlier, having a sensor element in the gas flow is a disadvantage since the element will be susceptible to the gas phase and hence corrosion. Again, this approach is not used in the current invention.

Imblum, in U.S. Pat. No. 5,780,715, describes an “electrical circuit for measuring the concentration level of a combustible gas comprising: a) a detector; b) a compensator; c) at least a pair of first electrical circuits, one of the pair electrically connected to the detector and the other of the pair electrically connected to the compensator, each circuit independently controlling the amount of electrical current passing through the detector or the compensator to which it is connected; . . . ”. As such, it is clear from the description that the detector and compensator has a current which is controlled externally. However, the current invention does not require external control or power input or a heating element or control of a heating element as the previous inventions and therefore is inherently simpler is less susceptible to failure.

Additionally, a further approach that is commonly described in the patent literature is an electrochemical method. This technique has been put into commercial practice. For example, some commercial oxygen sensors use a probe which must contact the gas stream. The oxygen in the gas stream diffuses through a membrane in the probe to an electrochemical cell where it is electrochemically reduced to water. The current required by the electrochemical cell to carry out the reduction is proportional to the oxygen concentration in the gas stream. The device is quantitative, but requires frequent calibration and has a limited life. This device is not ideal for continuous monitoring of a gas stream because of the required calibration nor would it be suitable for providing an alarm signal because of its durability and the need for constant recalibration.

Kitanoya, et al. describe in U.S. Pat. No. 6,913,677, a “hydrogen sensor, comprising a support element adapted to support a first electrode, a second electrode, and a reference electrode, the first electrode, the second electrode, and the reference electrode being provided in contact with a proton conduction layer, the support element having a diffusion controlling portion for establishing communication between an atmosphere containing a gas to be measured . . . ”. The technique relies on gas diffusion and an ionic conducting membrane and the measurement is similar to the operation of a PEM fuel cell. The device must have direct contact with the gas stream in order for the hydrogen to diffuse through the structure and be detected. In contrast, the current invention separates the measurement function from direct contact with the gas stream and uses a heat signature instead of a voltage generated by the electrochemical device from its contact with hydrogen gas.

Other known techniques include: resistance changes in a conductor due to gas composition; heat capacitance of the gas; optical changes in surface reflectivity due to gas composition change; permeation of hydrogen through a membrane and then detection or measurement is performed; and the like. However, none of these techniques use the thermal signature produced catalytically as a quantitative measure of gas composition.

### SUMMARY OF THE INVENTION

It is an object or goal of the present invention to provide a device for the quantitative measurement of contaminant gas, being namely hydrogen in an oxygen containing gas stream and/or oxygen in a hydrogen containing gas stream.

It is a further object or goal of the present invention to provide a device for such measurements that preferably provides quantitative measurements, reliable operation, long term durability, continuous operation and/or that is economical to operate.

It is a still further object or goal of the present invention to provide such a device which operates utilizing the heat generated by the catalysed reaction of hydrogen and oxygen.

The objectives and goals, as well as objects and goals inherent thereto, are at least partially or fully provided by the sensor of the present invention, as set out herein below.

The principle upon which the device is based is that a gas mixture which contains both hydrogen and oxygen, even when one component is at a very low concentration, will provide a heat signature as the gas is passed over a catalyst and the heat signature can be converted to an electrical signal which is proportional to the concentration of the gas mixture. The greater the concentration of the gas, the greater the signal. Since the heat signature can be sensed remotely, it is not required to have any electrical elements or devices in contact with the gas. This feature helps to provide longevity and avoid corrosion issues. Since the heat signature is generated via a chemical reaction, there is no requirement to provide internal or external electrical power or to provide fluid heating or cooling. This feature allows simplicity in the device. The catalyst can be distributed on an inert bed thus providing many redundant catalytic sites in case there are poisons in the gas mixture. This feature provides reliability.

The heat signature is a measurement of the heat difference between the original gas stream and the gas stream having undergone a reaction in the catalyst bed. The heat difference, or delta T, is measured via temperature sensing devices such as thermocouples, thermistors, optical or IR thermometers and the like. The temperature values can be converted into a display or an electrical signal for alarms or for concentration readout. The device, however, preferably provides a readout of the concentration of the contaminant gas which is essentially or substantially independent of system gas pressure, temperature and gas flow rate.

In particular, it will be noted that the temperature sensing elements can be physically separated from (although still operatively connected to) the gas stream being measured and thus the sensing elements do not have to operate under pressure or suffer from contact with the gases being measured.

Accordingly, in one aspect, the present invention provides a sensor for determining the concentration of a contaminant gas of either hydrogen gas in an oxygen containing gas stream, or oxygen gas in a hydrogen containing gas stream comprising a tube through which said oxygen containing or hydrogen containing gas stream passes, a catalyst bed located within said tube and in operative contact with at least a portion of said oxygen containing or hydrogen containing gas stream, a first temperature measurement device located within or operatively adjacent to said catalyst bed so as to measure a first measured temperature indicating the temperature of said catalyst bed or said gas stream within said catalyst bed, a second temperature measurement device located upstream of said catalyst bed so as to measure a second measured temperature indicating the temperature of said gas stream prior to reaching said catalyst bed, means for determining a temperature difference between said first and second measured temperatures, and a calibration model to relate said temperature difference to the level of said contaminant gas so as to determine the concentration of said contaminant gas, wherein said catalyst bed effects the reaction of hydrogen and oxygen in order to produce a heat of reaction.

In a further aspect, the present invention also provides a method for the determination of a contaminant gas of either hydrogen gas in an oxygen containing gas stream, or oxygen gas in a hydrogen containing gas stream comprising passing said gas stream through a sensor which sensor comprises a tube through which said gas stream passes, a catalyst bed located within said tube and in operative contact with said gas stream, measuring a first temperature using a first temperature measurement device located within or operatively adjacent to said catalyst bed so as to determine the a first temperature indicating the temperature of said catalyst bed or of said gas stream within said catalyst bed, measuring a second temperature using a second temperature measurement device located upstream of said catalyst bed so as to determine a second measured temperature indicating the temperature of said gas stream prior to reaching said catalyst bed, determining a temperature difference between said first and second measured temperatures, and relating said temperature difference to a calibration model so as to determine the concentration of said contaminant gas, wherein said catalyst bed effects the reaction of hydrogen and oxygen in order to produce a heat of reaction.

If concentrations at or greater than the explosive limit are possible, then a flame arrestor upstream of the catalyst should preferably be used.

### BRIEF DESCRIPTION OF THE DRAWINGS

In order that the invention may be better understood, preferred embodiments will now be described, by way of example only, with reference to the attached drawings wherein:

FIG. 1 is a schematic diagram of an apparatus according to the invention;

FIG. 2 is a second embodiment of a gas sensor of the present invention;

FIG. 3 is a graph of Sensor Response T1-T2 as a function of oxygen content; and

FIG. 4 is a graph of Sensor Response T1-T2 as a function of hydrogen content.

### DETAILED DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

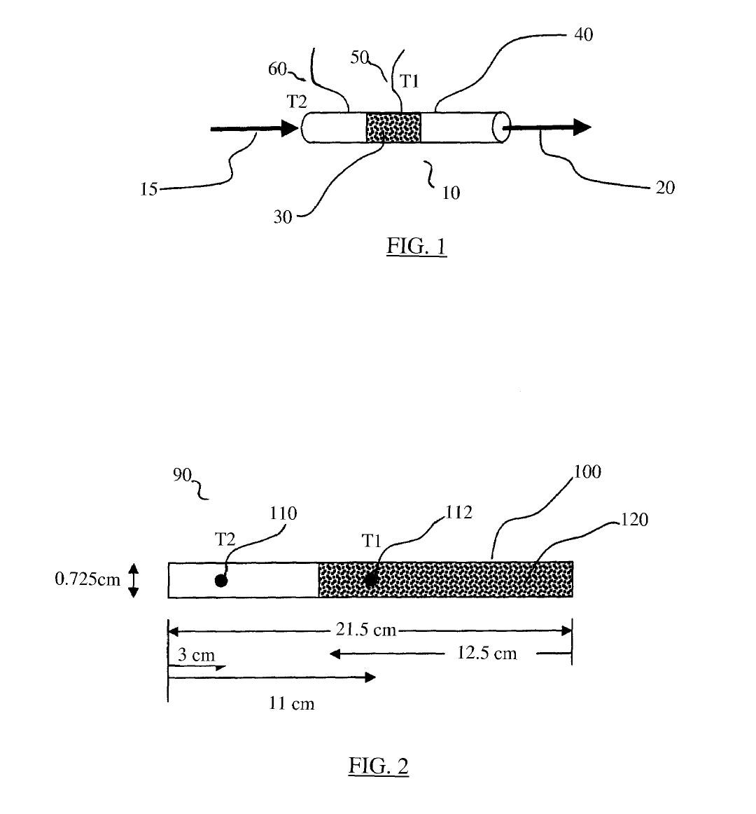

Referring to FIG. 1, a gas sensor device 10 according to the present invention is shown, having a gas inlet stream 15, a gas outlet stream 20, a tube 40 for gas flow through sensor 10, a catalyst bed 30, a catalyst bed temperature sensor T1 being thermocouple 50, and an upstream gas temperature sensor T2 being thermocouple 60.

In operation, hydrogen gas containing oxygen contamination flows into the tube 40 of gas detector 10 as gas stream 15. The gas temperature T2 is measured using thermocouple 60. The gas passes through catalyst bed 30 where the reaction H₂+½O₂=H₂O takes place releasing heat. The heated gas temperature T1 is recorded using thermocouple 50. The gas exits the gas detector 20. The difference in temperature, namely delta T, and measured as T1-T2, is a measure of the concentration of the oxygen content of the hydrogen gas stream.

The gas detector casing for tube 40 may be made of any glass, polymer or metal capable of withstanding the pressure of the gas and the temperature T1.

The gas temperature sensing sensors 50, 60 may be thermocouples, but might also be thermistors, resistance temperature detectors, infrared sensors, IR thermometers, or mixtures thereof, or any other suitable temperature sensing device. The temperature sensors may be placed on the outside surface of casing 40, as shown in FIG. 1. However, for more rapid response, either or both of the temperature sensors 50, 60 may be placed in “wells” in the casing of tube 40 (not shown in the Figures). Alternatively, either or both of the temperature sensors 50, 60 may be placed directly in either gas stream 15 or catalyst bed 30 via sealed ports in the casing of tube 40 (not shown in the Figures).

The catalyst bed can be any suitable catalyst that will cause the reaction of hydrogen with oxygen. Suitable catalyst include, for example, precious metals such as platinum, palladium, ruthenium or their alloys, or transitional metals such as nickel, cobalt, vanadium, and the like, and their alloys, or compounds such as perovskites and the like. While no specific shape, size or form is particularly necessary, use of an inert support material is preferred. In particular, preferred catalysts comprise a platinum catalyst supported on alumina, or a palladium catalyst supported on either alumina or silica. However, if carbon monoxide is a contaminant of the system, a platinum alloy catalyst is preferred.

The relative levels of the two gases can vary. However, preferably in a hydrogen containing gas stream, the level of oxygen is below 10% by weight, more preferably less than 8% by weight, and most preferably less than 6% by weight. In an oxygen containing gas stream, preferably the level of hydrogen is below 8% by weight, more preferably less than 6% by weight, and most preferably less than 4% by weight.

If quantitative measurement of the gas composition is required, the electrical signal for the temperature difference T1-T2, or delta T, is, or preferably should be, calibrated against known concentrations of gas, in a manner known to those skilled in the art. Once calibrated, it is to be noted that device 10 will be almost insensitive to total gas pressure or flow rate of gas, or at least is relatively insensitive to the gas pressure or flow rate.

The electrical signal recorded for the temperature difference T1-T2 may be amplified to drive a digital or analog meter for gas purity determination or set to trigger an alarm if the signal exceeds a threshold value for safety purposes.

Alternatively, an alarm could be included which is based merely on the temperature measured at T1, namely, at the temperature of the catalyst bed. If the level of one component or another is, for example, excessive, the temperature of the catalyst will be relatively high, and this can trigger an alarm regardless of the temperature measured at T2.

In FIG. 2, additional details of one specific embodiment of the present invention is shown. In this embodiment, gas sensor 90 for detecting the oxygen content of a hydrogen gas stream was constructed of ⅝″ OD thin walled 316SS tube 100 which was 21.5 cm in length. Approximately 20 g of a 0.5% Pt/g alumina (shaped as 3.175 mm pellets) catalyst bed 120 was inserted into, and extends for 12.5 cm from a first end of the tube. Thermistors 110 and 112 were placed on the exterior of the tube at 3 cm and 11 cm, respectively, from the opposite, second end of tube 100 so that one of thermistors 112 was positioned adjacent to catalyst bed 120. The two thermistors 110 and 112 were used to determine the T1-T2 value.

Alternatively, for measuring the hydrogen content in an oxygen stream the thermistors 110 and 112 can be placed at 3 cm and 14 cm from the second end of tube 100 in order to optimize the T1-T2 value.

Tubes 40 or 100 can be large enough to handle the entire gas flow, and all of the gas flows through the catalyst bed. However, tubes 40 or 100 might be used to test a relatively small side stream sample removed from a larger gas flow.

Further, the amount of catalyst used is preferably small enough that the gas stream can be tested. Alternatively, however, the catalyst bed can be large enough to provide a significant reduction (e.g. greater than 50% reduction) in the amount of contaminant gas present in the gas stream.

Also, the catalyst can be used to essentially cover the entire diameter of the tube, or can be used to cover merely a portion of the tube, such as, for example, an annular ring around the outer perimeter of the inside of the tube. Various embodiments of the tube and catalyst shape and size can be envisioned.

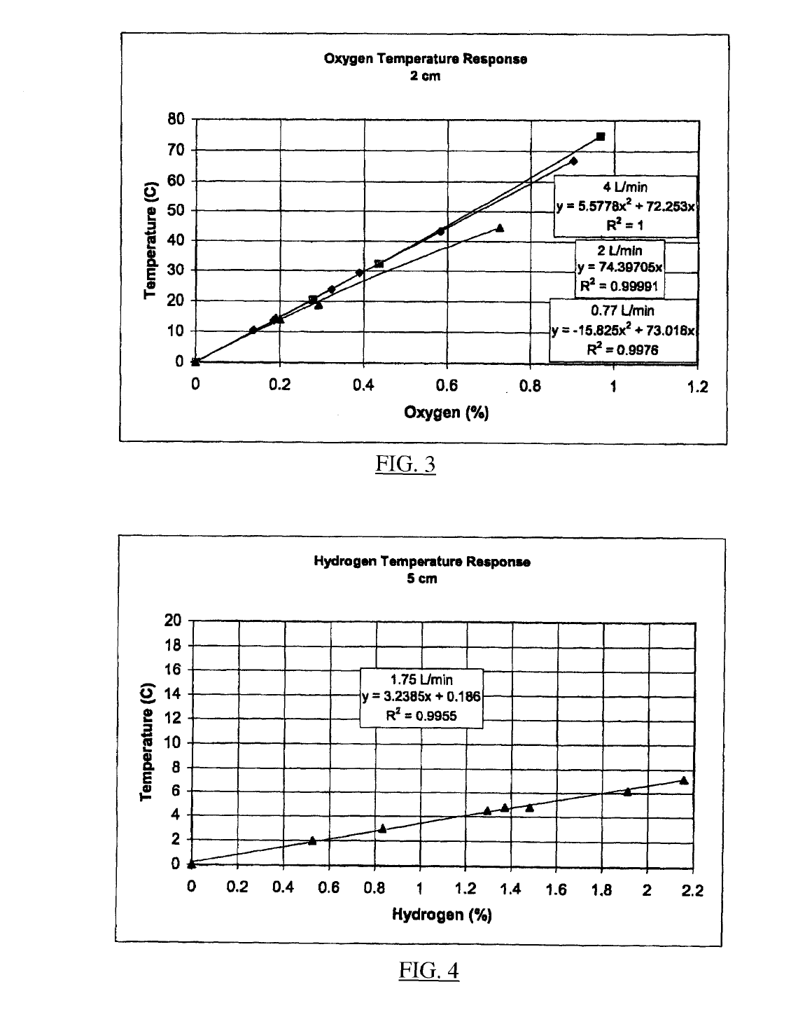

In FIG. 3, a graph of sensor response T1-T2 as a function of oxygen content in a hydrogen stream, is shown for a given test procedure. Hydrogen and oxygen from separate gas cylinders were controlled using a valve and calibrated flow meter for each gas. The gases flowed into a T-junction where they mixed and then flowed into a single tube connected to the sensor 90 shown in FIG. 2. The actual percentage of oxygen in the hydrogen stream was set by the flow meters, and the precise composition was confirmed with an electrochemical sensor (Teledyne Oxygen meter model 320B). The T1-T2 response of the sensor is shown as a function of the gas composition in FIG. 3. As can be seen from FIG. 3, the T1-T2 response is linear with percent oxygen. The degree of linearity is indicated by the R2 value where 1 represents a perfect linear fit to the equation shown. The figure also shows the response is essentially the same at different flow rates, namely at 4 litres per minute, 2 l/min, or 0.77 l/min. As a result, the similarity of the response lines effectively allows the same calibration model to be used for a variety of different gas flow rates. Similarly, a single calibration model can be used for a variety of different gas pressures and inlet temperature. Consequently, for most purposes, a single calibration model can be used to provide usable results over a wide range of operating conditions without the need for constant recalibration.

Also, it is noted that the response T1-T2 is relatively quite large so that the signal is easy to detect. This feature also means that the T1-T2 signal can be used to provide a quantitative measure of the oxygen content as well as provide a signal for an alarm.

Additionally, it should be noted that the concentration of the oxygen in the gas stream after sensor 90 was not detectable by the Teledyne Oxygen meter indicating that a quantitative removal of the oxygen content had occurred in sensor 90. This indicates that the catalyst bed was large enough to impact the composition of the gas stream.

In FIG. 4, a graph of sensor response T1-T2 as a function of hydrogen in an oxygen stream is shown. Again, hydrogen and oxygen from gas cylinders were controlled using a valve and calibrated flow meter for each gas. The gases flowed into a T-junction where they mixed and then flowed into a single tube connected to the sensor shown in FIG. 2. The percentage of oxygen in the hydrogen stream was again set by the flow meters. The T1-T2 response of sensor 90 is shown as a function of the gas composition in FIG. 4. As can be seen from FIG. 4, the T1-T2 response is linear with percent hydrogen (R=0.9955). The response T1-T2 is again relatively large so that the signal is easy to detect. This feature also means that the T1-T2 signal can be used to provide a quantitative measure of the hydrogen content in an oxygen stream as well as provide a signal for an alarm.

As can be seen and mentioned, the delta T response is fairly linear in the graphs shown in FIGS. 3 and 4. Preferably, the delta T response is linear over a 0-2% gas contamination range (e.g. either hydrogen in an oxygen stream, or oxygen in a hydrogen stream). More preferably, the delta T response is linear over a 0-4% gas contamination range.

Thus, it is apparent that there has been provided, in accordance with the present invention, a simple, inexpensive, hydrogen/oxygen gas sensor which fully satisfies the goals, objects, and advantages set forth hereinbefore. The gas sensor is simple to produce, and is reliable. Further, it does not require external or internal electronics such as external temperature controls or the like. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A sensor for determining the concentration of a contaminant gas of either hydrogen gas in an oxygen containing gas stream, or oxygen gas in a hydrogen containing gas stream comprising a tube through which said oxygen containing or hydrogen containing gas stream passes, a catalyst bed located within said tube and in operative contact with at least a portion of said oxygen containing or hydrogen containing gas stream, a first temperature measurement device located within or operatively adjacent to said catalyst bed so as to measure a first measured temperature indicating the temperature of said catalyst bed or said gas stream within said catalyst bed, a second temperature measurement device located upstream of said catalyst bed so as to measure a second measured temperature indicating the temperature of said gas stream prior to reaching said catalyst bed, means for determining a temperature difference between said first and second measured temperatures, and a calibration model to relate said temperature difference to the level of said contaminant gas so as to determine the concentration of said contaminant gas, wherein said catalyst bed effects the reaction of hydrogen and oxygen in order to produce a heat of reaction.

2. A sensor as claimed in claim 1 wherein said sensor provides a quantitative measurement of said contaminant gas.

3. A sensor as claimed in claim 1 wherein said temperature difference provides a heat signature, and said heat signature is converted to an electrical signal which is proportional to the concentration of said contaminant gas.

4. A sensor as claimed in claim 3 wherein said heat signature is remotely sensed.

5. A sensor as claimed in claim 1 wherein said first and second temperatures as measured using temperature sensing devices selected from the group consisting of thermocouples, thermistors, resistance temperature detectors, infrared sensors, optical or IR thermometers, or mixtures thereof.

6. A sensor as claimed in claim 1 wherein the relationship between said heat difference and said contaminant gas concentration is essentially independent of the gas pressure, temperature or flow rate.

7. A sensor as claimed in claim 1 wherein said first or second temperature measurement devices are placed on the outside of said tube, within a well provided in said tube, or extend through said tube into said gas stream or said catalyst bed.

8. A sensor as claimed in claim 1 wherein said catalyst bed comprises a precious metal or a transitional metal, or alloys thereof, on an inert substrate.

9. A sensor as claimed in claim 8 wherein said catalyst bed comprises platinum, palladium, nickel, or an alloy thereof, on an alumina or silica substrate.

10. A sensor as claimed in claim 9 wherein said catalyst bed comprises a platinum or palladium alloy on an alumina substrate.

11. A sensor as claimed in claim 1 wherein said gas stream is a hydrogen containing gas stream, and said contaminant gas is oxygen at a level of less than 6% by weight.

12. A sensor as claimed in claim 1 wherein said gas stream is an oxygen containing gas stream, and said contaminant gas is hydrogen at a level of less than 4% by weight.

13. A sensor as claimed in claim 1 additionally comprising an alarm signal which is triggered solely based on the temperature reading from said first temperature measurement device.

14. A sensor as claimed in claim 1 wherein said catalyst bed effects a significant reduction in the amount of contaminant gas present in said gas stream.

15. A sensor as claimed in claim 13 wherein said catalyst bed effectively removes said contaminant gas from said gas stream.

16. A sensor as claimed in claim 1 wherein said relationship of said temperature difference to said contaminant gas concentration is a linear relationship over a 0 to 4% contaminant gas concentration.

17. A method for the determination of a contaminant gas of either hydrogen gas in an oxygen containing gas stream, or oxygen gas in a hydrogen containing gas stream comprising passing said gas stream through a sensor which sensor comprises a tube through which said gas stream passes, a catalyst bed located within said tube and in operative contact with said gas stream, measuring a first temperature using a first temperature measurement device located within or operatively adjacent to said catalyst bed so as to determine the a first temperature indicating the temperature of said catalyst bed or of said gas stream within said catalyst bed, measuring a second temperature using a second temperature measurement device located upstream of said catalyst bed so as to determine a second measured temperature indicating the temperature of said gas stream prior to reaching said catalyst bed, determining a temperature difference between said first and second measured temperatures, and relating said temperature difference to a calibration model so as to determine the concentration of said contaminant gas, wherein said catalyst bed effects the reaction of hydrogen and oxygen in order to produce a heat of reaction.
